(19) United States
(12) Patent Application Publication
(10) Pub. No.: US 2026/0366101 A1
(43) Pub. Date: Nov. 19, 2026

(54) PRETREATMENT METHOD FOR LITHIUM SECONDARY BATTERY RECYCLING

(71) Applicant: SUNGEEL HITECH CO. LTD, Gunsan-si (KR)

(72) Inventors: Suk-Hyun BYUN, Gunsan-si (KR); Ah Reum LEE, Gunsan-si (KR); Hyeon Jun KIM, Gunsan-si (KR)

(21) Appl. No.: 19/136,454

(22) PCT Filed: Dec. 11, 2023
(86) PCT No.: PCT/KR2023/020290

§ 371 Date: Jun. 6, 2025

(30) Foreign Application Priority Data
Dec. 13, 2022 (KR) 10-2022-0173870
Dec. 8, 2023 (KR) 10-2023-0177986

(51) Int. Cl. C22B 7/00; C22B 1/248; C22B 15/00; C22B 21/00; H01M 10/54

(52) U.S. Cl. CPC C22B 7/005; C22B 1/248; C22B 15/0006; C22B 21/0069; H01M 10/54

(57) ABSTRACT

The present invention relates to a pretreatment method for lithium secondary battery recycling, comprising the steps of: physically discharging waste lithium secondary battery packs, and then dismantling same and cutting terminals so as to manufacture waste lithium secondary battery cells, thereby separating out cell terminals and plastics; punching the waste lithium secondary battery cells; putting same into a closed nitrogen shredder and shredding same, and then injecting the shredded products generated thereby into a closed drying furnace so as to heat same while injecting nitrogen, thereby evaporating and drying organic materials so that the evaporated organic materials are recovered; cooling, to room temperature, the dried shredded products; and pulverizing and sorting the dried shredded products. The pretreatment method for a lithium secondary battery recycling injects nitrogen into the closed drying furnace, maintains the temperature inside a closed tube to be constant, and then applies heat to the shredded products so as to effectively evaporate and recover organic materials of the waste batteries, thereby controlling impurities of the waste batteries.

### TECHNICAL FIELD

The present disclosure relates to a pretreatment method for lithium secondary battery recycling for controlling impurities of waste batteries and recovering an electrolyte.

### BACKGROUND ART

As of 2018, the cumulative number of electric vehicles distributed in Korea was approximately 57,000, and the Korean government plans to expand this number to 3 million by 2030 according to the “2030 National Roadmap.” Accordingly, the volume of waste batteries generated from electric vehicles is also expected to increase significantly.

The lithium secondary batteries used in electric vehicles have the same composition as those used in small IT devices, including a cathode active material, an anode active material, a separator, and an electrolyte.

As the cathode active material in small lithium secondary batteries, LiCoO₂ (LCO), which has excellent discharge performance and high capacity, is used. As the cathode active materials for medium and large sized lithium secondary batteries, materials such as Li[NiₓAl_{y}Co_{z}]O₂(NCA) and Li[NiₓCo_{y}Mn_{z}]O₂(NCM) are used, as they are cost-effective and capable of high output.

In general, a lithium secondary battery recycling process refers to the process of extracting valuable metals from the cathode active material of waste batteries. As most of these valuable metals are imported, it is necessary to ensure a stable supply of materials through lithium secondary battery recycling.

In such a recycling process, a battery drying process is performed as a pretreatment step.

However, in conventional drying processes, the occurrence of fires within the equipment causes temperature non-uniformity. As a result, copper (Cu) becomes brittle and aluminum (Al) oxidizes, leading to significant impurity contamination (e.g., Cu, Al).

Furthermore, if the heat treatment temperature is too low, the organic materials inside the battery cannot be removed.

In addition, conventional processes are environmentally disadvantageous in terms of carbon neutrality, because the hydrocarbon gases generated during primary combustion are released as CO₂ through secondary combustion.

Through extensive effort and research, the applicant has completed the present disclosure by developing a pretreatment method for lithium secondary battery recycling for controlling impurities of waste batteries and recovering an electrolyte, which addresses the above issues.

### DISCLOSURE

### Technical Problem

Accordingly, a purpose of the present disclosure is to provide a pretreatment method for lithium secondary battery recycling for controlling impurities of waste batteries and recovering an electrolyte.

The problems to be solved by the present disclosure are not limited to those mentioned above, and other problems not mentioned will be clearly understood by those skilled in the art from the following description.

### Technical Solution

In order to achieve the purpose, an aspect of the present disclosure provides a pretreatment method for lithium secondary battery recycling, comprising:
(a-1) electrically discharging a waste lithium secondary battery module or a waste lithium secondary battery pack so as to obtain the waste lithium secondary battery module in a discharged state or the waste lithium secondary battery pack in a discharged state;
(a-2) dismantling the waste lithium secondary battery pack into a waste lithium secondary battery module;
(a-3) cutting a terminal of the waste lithium secondary battery module so as to manufacture a waste lithium secondary battery cell, and separating the terminal and plastics from the waste lithium secondary battery cell;
(a-4) punching the waste lithium secondary battery cell;
(a-5) injecting nitrogen into a closed nitrogen shredder, and shredding the punched waste lithium secondary battery cell so as to obtain a shredded product;
(a-6) applying heat, while injecting nitrogen, to the obtained shredded product in a closed drying furnace so as to evaporate an organic material and dry the shredded product;
(a-7) recovering the evaporated organic material;
(a-8) cooling the obtained dried shredded product to room temperature; and
(a-9) pulverizing and sorting the obtained shredded product,
wherein, in the pretreatment method for lithium secondary battery recycling, nitrogen is injected into the closed drying furnace, a temperature inside a closed tube is maintained to be constant, and then heat is applied to the shredded product so as to effectively evaporate and recover the organic material of a waste battery, thereby controlling impurities of the waste battery.

In some exemplary embodiments, in the step (a-1) of electrically discharging a waste lithium secondary battery module or a waste lithium secondary battery pack so as to obtain the waste lithium secondary battery module in a discharged state or the waste lithium secondary battery pack in a discharged state,
the electrical discharge may be performed by discharging for 1.5 to 3 hours and then short-circuiting for 24 hours.

In some exemplary embodiments, in the step (a-3) of cutting a terminal of the waste lithium secondary battery module so as to manufacture a waste lithium secondary battery cell, and separating the terminal and plastics from the waste lithium secondary battery cell, the terminal may be cut by using a terminal cutter,
the terminal and plastics may be separated by using the terminal cutter, and
the terminal cutter may include an insulated terminal cutter, a metal cutter, or a high-speed cutter.

In some exemplary embodiments, in the step (a-4) of punching the waste lithium secondary battery cell,
a physical discharge may be performed by the punching.

In some exemplary embodiments, in the step (a-5) of injecting nitrogen into a closed nitrogen shredder, and shredding the punched waste lithium secondary battery cell so as to obtain a shredded product,
the shredding may be performed by using a shredder, a jaw crusher, or a cone crusher.

In some exemplary embodiments, in the step (a-5) of injecting nitrogen into a closed nitrogen shredder, and shredding the punched waste lithium secondary battery cell so as to obtain a shredded product,
the closed nitrogen shredder may be supplied through a conveyor under a nitrogen atmosphere.

In some exemplary embodiments, in the step (a-5) of injecting nitrogen into a closed nitrogen shredder, and shredding the punched waste lithium secondary battery cell so as to obtain a shredded product,
the closed nitrogen shredder may be a two-stage nitrogen shredder,
wherein a first-stage size of the two-stage nitrogen shredder may be 30 to 60 mm in width and 130 to 200 mm in length, and
a second-stage size of the two-stage nitrogen shredder may be 15 to 30 mm in width and 20 to 130 mm in length.

In some exemplary embodiments, in the step (a-6) of applying heat, while injecting nitrogen, to the obtained shredded product in a closed drying furnace so as to evaporate an organic material and dry the shredded product,
the nitrogen may be introduced into the closed drying furnace through a closed transfer conveyor after passing through a nitrogen shredder.

In some exemplary embodiments, in the step (a-6) of applying heat, while injecting nitrogen, to the obtained shredded product in a closed drying furnace so as to evaporate an organic material and dry the shredded product,
the evaporation of the organic materials may be performed in the closed drying furnace with nitrogen injected therein,
and the closed drying furnace may be at least one selected from the group consisting of a rotary kiln, a rotary dryer, a tunnel furnace, a box furnace, and a furnace having a closed structure.

In some exemplary embodiments, in the step (a-6) of applying heat, while injecting nitrogen, to the obtained shredded product in a closed drying furnace so as to evaporate an organic material and dry the shredded product,
the evaporation of the organic materials may be performed by an indirect heating method at a temperature of 100 °C to 800 °C.

In some exemplary embodiments, in the step (a-6) of applying heat, while injecting nitrogen, to the obtained shredded product in a closed drying furnace so as to evaporate an organic material and dry the shredded product,
the organic material may be at least one selected from the group consisting of a combustible material including carbon or hydrogen, moisture, and ash.

In some exemplary embodiments, in the step (a-7) of recovering the evaporated organic material, a device for recovering the evaporated organic material may be at least one selected from the group consisting of a condenser, a cooling tower, a refrigerator, a heat exchanger, and a multi-pipe heat exchanger.

In some exemplary embodiments, in the step (a-8) of cooling the obtained dried shredded product to room temperature,
the cooling of the obtained dried shredded product may be performed in a closed cooling device,
and the closed cooling device may be at least one selected from the group consisting of a rotary type, a tunnel type, and a box type.

In some exemplary embodiments, in the step (a-8) of cooling the obtained dried shredded product to room temperature,
the cooling may be performed by an indirect cooling method using a refrigerant in a closed cooling device at a temperature of 15 °C to 30 °C.

In some exemplary embodiments, in the step (a-8) of cooling the obtained dried shredded product to room temperature,
the dried shredded product discharged from the closed cooling device may be discharged at a temperature of 25 °C to 40 °C.

In some exemplary embodiments, in the step (a-9) of pulverizing and sorting the obtained shredded product,
a pulverizer for the pulverizing may be at least one selected from the group consisting of a rod mill, a pin mill, a ball mill, a tube mill, a pot mill, a roller mill, a turbo mill, an impact mill, a cut mill, and a tower mill.

In some exemplary embodiments, in the step (a-9) of pulverizing and sorting the obtained shredded product,
a size of the pulverized waste lithium secondary battery may range from 10 am to 15 mm.

In some exemplary embodiments, in the step (a-9) of pulverizing and sorting the obtained shredded product,
a device for the sorting may be at least one selected from the group consisting of a gravity separator, a specific gravity separator, a vibrating separator, a magnetic separator, an electrostatic separator, a pneumatic separator, a flotation separator, and an optical separator.

In some exemplary embodiments, in the step (a-9) of pulverizing and sorting the obtained shredded product,
the obtained shredded product may be sorted into at least one selected from the group consisting of a cathode active material, an anode active material, copper (Cu), and aluminum (Al).

In some exemplary embodiments, in the step (a-9) of pulverizing and sorting the obtained shredded product,
a valuable metal powder recovered by the pulverizing and sorting may include a compound of at least one valuable metal selected from the group consisting of lithium, nickel, manganese, cobalt, iron, aluminum, and copper.

In some exemplary embodiments, the waste battery may be at least one lithium secondary battery selected from the group consisting of a waste battery of an electric vehicle, a waste battery of an energy storage system (ESS), a waste battery of an electronic product, and a waste battery of a mobile phone.

In some exemplary embodiments, the waste battery may include at least one selected from the group consisting of a cathode active material, an anode active material, a separator, a copper (Cu) foil, an aluminum (Al) foil, and an electrolyte.

### Advantageous Effects

According to the present disclosure, a pretreatment method for lithium secondary battery recycling is provided for controlling impurities of waste batteries and recovering an electrolyte, thereby reducing the cost of lithium secondary battery recycling, improving the efficiency of the pretreatment process, and increasing the material recycling rate.

In addition, the present disclosure provides an environmentally friendly pretreatment method for waste batteries by preventing fire and explosion during the shredding and drying processes of waste battery pretreatment, and recovering evaporated organic compounds in the form of oil, gas, or ash, without using a combustion device.

The effects of the present disclosure are not limited to those described above, but should be understood to include all effects that can be inferred from the configuration of the present disclosure as defined in the claims and/or the detailed description.

### DESCRIPTION OF DRAWINGS

FIG. 1 is a process flow diagram of a pretreatment method for lithium secondary battery recycling according to an exemplary embodiment of the present disclosure.

### MODE FOR INVENTION

Hereinafter, exemplary embodiments of the present disclosure will be described in detail with reference to the accompanying drawings.

Advantages, features, and methods of achieving the present disclosure will become more apparent from the following detailed description of exemplary embodiments, which should be read in conjunction with the accompanying drawings.

However, it should be understood that the present disclosure is not limited to the exemplary embodiments disclosed herein, which may be embodied in various other forms. Rather, these exemplary embodiments are provided such that this disclosure will be thorough and complete, and will fully convey the scope of the invention to those skilled in the art.

In addition, in describing the present disclosure, detailed descriptions of well-known technologies may be omitted so as not to obscure the essence of the present disclosure.

Hereinafter, exemplary embodiments of the present disclosure will be described in detail.

### Pretreatment Method for Lithium Secondary Battery Recycling

The present disclosure provides a pretreatment method for lithium secondary battery recycling for controlling impurities of waste batteries and recovering an electrolyte.

According to an exemplary embodiment of the present disclosure, there is provided a pretreatment method for lithium secondary battery recycling, comprising:
(a-1) electrically discharging a waste lithium secondary battery module or a waste lithium secondary battery pack so as to obtain the waste lithium secondary battery module in a discharged state or the waste lithium secondary battery pack in a discharged state;
(a-2) dismantling the waste lithium secondary battery pack into a waste lithium secondary battery module;
(a-3) cutting a terminal of the waste lithium secondary battery module so as to manufacture a waste lithium secondary battery cell, and separating the terminal and plastics from the waste lithium secondary battery cell;
(a-4) punching the waste lithium secondary battery cell;
(a-5) injecting nitrogen into a closed nitrogen shredder, and shredding the punched waste lithium secondary battery cell so as to obtain a shredded product;
(a-6) applying heat, while injecting nitrogen, to the obtained shredded product in a closed drying furnace so as to evaporate an organic material and dry the shredded product;
(a-7) recovering the evaporated organic material;
(a-8) cooling the obtained dried shredded product to room temperature; and
(a-9) pulverizing and sorting the obtained shredded product,
wherein, in the pretreatment method for lithium secondary battery recycling, nitrogen may be injected into the closed drying furnace, a temperature inside a closed tube may be maintained to be constant, and then heat may be applied to the shredded product so as to effectively evaporate and recover the organic material of a waste battery, thereby controlling impurities of the waste battery.

The present disclosure provides a pretreatment method for lithium secondary battery recycling for controlling impurities of waste batteries and recovering an electrolyte, thereby reducing the cost of lithium secondary battery recycling, improving the efficiency of the pretreatment process, and increasing the material recycling rate.

In addition, the present disclosure provides an environmentally friendly pretreatment method for waste batteries by preventing fire and explosion during the shredding and drying processes of waste battery pretreatment and recovering evaporated organic materials in the form of oil, gas, or ash without using a combustion device.

As of 2018, the cumulative number of electric vehicles distributed in Korea was approximately 57,000, and the Korean government plans to expand this number to 3 million by 2030 according to the “2030 National Roadmap”. Accordingly, the volume of waste batteries generated from electric vehicles is also expected to increase significantly.

The lithium secondary batteries used in electric vehicles have the same composition as those used in small IT devices, including a cathode active material, an anode active material, a separator, and an electrolyte.

As the cathode active material in small lithium secondary batteries, LiCoO₂ (LCO), which has excellent discharge performance and high capacity, is used. As the cathode active materials for medium and large sized lithium secondary batteries, materials such as Li[NiₓAl_{y}Co_{z}]O₂(NCA) and Li[NiₓCo_{y}Mn_{z}]O₂(NCM) are used, as they are cost-effective and capable of high output.

In general, a lithium secondary battery recycling process refers to the process of extracting valuable metals from the cathode active material of waste batteries. As most of these valuable metals are imported, it is necessary to ensure a stable supply of materials through lithium secondary battery recycling.

In such a recycling process, a battery drying process is performed as a pretreatment step.

However, in conventional drying processes, the occurrence of fires within the equipment causes temperature non-uniformity. As a result, copper (Cu) becomes brittle and aluminum (Al) oxidizes, leading to significant impurity contamination (e.g., Cu, Al).

Furthermore, if the heat treatment temperature is lowered, the organic materials inside the battery may not be removed.

In addition, conventional processes are environmentally disadvantageous in terms of carbon neutrality, because the hydrocarbon gases generated during primary combustion are released as CO₂ through secondary combustion.

Through extensive effort and research, the applicant has completed the present disclosure by developing a pretreatment method for lithium secondary battery recycling for controlling impurities of waste batteries and recovering an electrolyte, which addresses the above issues.

Here, in the pretreatment method for lithium secondary battery recycling, nitrogen may be injected into the closed drying furnace, a temperature inside the closed tube may be maintained to be constant, and then heat is applied to the shredded product so as to effectively evaporate and recover the organic material of a waste battery, thereby controlling impurities of the waste battery.

In addition, in the step (a-1) of electrically discharging a waste lithium secondary battery module or a waste lithium secondary battery pack so as to obtain the waste lithium secondary battery module in a discharged state or the waste lithium secondary battery pack in a discharged state,
the electrical discharge may be performed by discharging for 1.5 to 3 hours and then short-circuiting for 24 hours.

Here, when the electrical discharge time is within the above range, the discharge efficiency may be excellent.

In addition, in the step (a-3) of cutting a terminal of the waste lithium secondary battery module so as to manufacture a waste lithium secondary battery cell, and separating the terminal and plastics from the waste lithium secondary battery cell, the terminal may be cut by using a terminal cutter,
the terminal and plastics may be separated by using the terminal cutter, and
the terminal cutter may include an insulated terminal cutter, a metal cutter, or a high-speed cutter.

Furthermore, in the step (a-4) of punching the waste lithium secondary battery cell,
a physical discharge may be performed by the punching.

Here, the discharge process may be completed by the electrical discharge and the physical discharge by the punching.

In addition, in the step (a-5) of injecting nitrogen into a closed nitrogen shredder, and shredding the punched waste lithium secondary battery cell so as to obtain a shredded product,
the shredding may be performed by using a shredder, a jaw crusher, or a cone crusher.

Moreover, in the step (a-5) of injecting nitrogen into a closed nitrogen shredder, and shredding the punched waste lithium secondary battery cell so as to obtain a shredded product,
the closed nitrogen shredder may be supplied through a conveyor under a nitrogen atmosphere.

Here, the closed nitrogen shredder may be continuously supplied with nitrogen in a sealed state.

In addition, in the step (a-5) of injecting nitrogen into a closed nitrogen shredder, and shredding the punched waste lithium secondary battery cell so as to obtain a shredded product,
the closed nitrogen shredder may be a two-stage nitrogen shredder,
wherein a first-stage size of the two-stage nitrogen shredder may be 30 to 60 mm in width and 130 to 200 mm in length, and
a second-stage size of the two-stage nitrogen shredder may be 15 to 30 mm in width and 20 to 130 mm in length.

Here, when the size of the two-stage nitrogen shredder of the closed nitrogen shredder is within the above range, the shredding efficiency may be superior, and the surface area may be increased by shredding, thereby improving the efficiency of subsequent heat treatment.

In addition, in the step (a-6) of applying heat, while injecting nitrogen, to the obtained shredded product in a closed drying furnace so as to evaporate an organic material and dry the shredded product,
the nitrogen may be introduced into the closed drying furnace through a closed transfer conveyor after passing through a nitrogen shredder.

Here, since the nitrogen passes through a nitrogen shredder and then passes through a closed transfer conveyor, when the obtained shredded product is introduced into the closed drying furnace, the oxygen concentration can be easily controlled.

In this case, the nitrogen is introduced for the purpose of preventing fire and explosion during shredding of residual batteries with a remaining state of charge (SOC), and accordingly, the oxygen concentration inside the facility can be maintained at 0.1 to 10% by volume.

Furthermore, in the step (a-6) of applying heat, while injecting nitrogen, to the obtained shredded product in a closed drying furnace so as to evaporate an organic material and dry the shredded product,
the evaporation of the organic materials may be performed in the closed drying furnace with nitrogen injected therein,
and the closed drying furnace may be at least one selected from the group consisting of a rotary kiln, a rotary dryer, a tunnel furnace, a box furnace, and a furnace having a closed structure.

Moreover, in the step (a-6) of applying heat, while injecting nitrogen, to the obtained shredded product in a closed drying furnace so as to evaporate an organic material and dry the shredded product,
the evaporation of the organic materials may be performed by an indirect heating method at a temperature of 100 °C to 800 °C.

Here, when the evaporation temperature of the organic material deviates from the above range, the evaporation efficiency of the organic material may decrease, and it may become difficult to recover the dried powder of the waste battery.

Preferably, the evaporation temperature of the organic material may be 200 °C to 700 °C, and more preferably, 300 °C to 600 °C.

In addition, by injecting nitrogen into the closed tube during the evaporation of the organic material and thereby evaporating the organic material, the organic material can be evaporated without fire or explosion.

Further, the indirect heating method can suppress rapid temperature rise, thereby increasing the evaporation efficiency of the organic material and facilitating the recovery of the dried waste battery powder.

Moreover, by injecting nitrogen into the closed tube and evaporating the organic material, the pretreatment temperature of the waste battery can be uniformly maintained, so that the organic material in the waste battery powder can be effectively evaporated, making it possible to recover the organic material through an air pollution control facility.

In addition, by injecting nitrogen into the closed tube and evaporating the organic material, the following problems can be addressed:

In conventional shredding and drying processes, safety is compromised due to the possibility of fire or explosion from incompletely discharged cells. In the event of an internal fire, materials within the process are dried above the designed temperature (1,000 °C or higher), resulting in the incorporation of unintended impurities other than the cathode active material, and an increase in the amount of chemicals required for controlling such impurities in the wet process.

In addition, in the step (a-6) of applying heat, while injecting nitrogen, to the obtained shredded product in a closed drying furnace so as to evaporate an organic material and dry the shredded product,
the organic material may be at least one selected from the group consisting of a combustible material including carbon or hydrogen, moisture, and ash.

Here, the organic material may comprise 50 to 95 wt % of combustible material, 0.5 to 35 wt % of moisture, or 0.2 to 30 wt % of ash, based on 100 wt % of the organic material.

Moreover, in the step (a-7) of recovering the evaporated organic material,
a device for recovering the evaporated organic material may be at least one selected from the group consisting of a condenser, a cooling tower, a refrigerator, a heat exchanger, and a multi-pipe heat exchanger.

Here, a device for recovering the evaporated organic material may recover the evaporated organic material based on a temperature difference.

In this case, a plurality of devices for recovering the evaporated organic material may be used.

The evaporated organic material may be recovered through the recovery device in the form of oil, gas, or ash.

Based on 100 wt % of the evaporated organic material, the respective proportions may be 10 to 20 wt % of a gaseous component, 50 to 70 wt % of a liquid component, and 10 to 20 wt % of ash, wherein the oil comprises olefin-based compounds such as CO, CH₄, H₂, CO₂, and CₙHₙ.

Furthermore, in the step (a-8) of cooling the obtained dried shredded product to room temperature,
the cooling of the obtained dried shredded product may be performed in a closed cooling device,
and the closed cooling device may be at least one selected from the group consisting of a rotary type, a tunnel type, and a box type.

Here, by introducing the dried shredded product into the closed cooling device and cooling the dried shredded product to room temperature, the following problems can be addressed.

That is, in a conventional system, the transport system for shredded products dried at 200 °C to 600 °C requires frequent replacement of consumable components due to the high temperature, and the operating rate of the plant is also reduced.

Here, in the step (a-8) of cooling the obtained dried shredded product to room temperature,
the cooling may be performed by an indirect cooling method using a refrigerant in a closed cooling device at a temperature of 15 °C to 30 °C.

In addition, in the step (a-8) of cooling the obtained dried shredded product to room temperature,
the dried shredded product discharged from the closed cooling device may be discharged at a temperature of 25 °C to 40 °C.

Moreover, in the step (a-9) of pulverizing and sorting the obtained shredded product,
a pulverizer for the pulverizing may be at least one selected from the group consisting of a rod mill, a pin mill, a ball mill, a tube mill, a pot mill, a roller mill, a turbo mill, an impact mill, a cut mill, and a tower mill.

Furthermore, in the step (a-9) of pulverizing and sorting the obtained shredded product,
a size of the pulverized waste lithium secondary battery may range from 10 μm to 15 mm.

Here, when the particle size of the pulverized waste lithium secondary battery deviates from the above range, it may be difficult to control impurities of the waste battery in the pretreatment method for lithium secondary battery recycling.

In this case, the particle size of the pulverized waste lithium secondary battery may be preferably 15 μm to 15 mm, and more preferably 20 μm to 10 mm.

In addition, in the step (a-9) of pulverizing and sorting the obtained shredded product,
a device for the sorting may be at least one selected from the group consisting of a gravity separator, a specific gravity separator, a vibrating separator, a magnetic separator, an electrostatic separator, a pneumatic separator, a flotation separator, and an optical separator.

Moreover, in the step (a-9) of pulverizing and sorting the obtained shredded product,
the obtained shredded product may be sorted into at least one selected from the group consisting of a cathode active material, an anode active material, copper (Cu), and aluminum (Al).

Furthermore, in the step (a-9) of pulverizing and sorting the obtained shredded product,
a valuable metal powder recovered by the pulverizing and sorting may include a compound of at least one valuable metal selected from the group consisting of lithium, nickel, manganese, cobalt, iron, aluminum, and copper.

Accordingly, the present disclosure can provide an environmentally friendly pretreatment process for waste batteries by preventing fire and explosion during the shredding and drying processes of waste battery pretreatment, recovering evaporated organic compounds in the form of oil, gas, or ash, thereby reducing the amount of chemicals used for impurity removal in the wet process, and recovering the organic compounds without using a combustion device.

In addition, the waste battery may be at least one lithium secondary battery selected from the group consisting of a waste battery of an electric vehicle, a waste battery of an energy storage system (ESS), a waste battery of an electronic product, and a waste battery of a mobile phone.

Furthermore, the waste battery may include at least one selected from the group consisting of a cathode active material, an anode active material, a separator, a copper (Cu) foil, an aluminum (Al) foil, and an electrolyte.

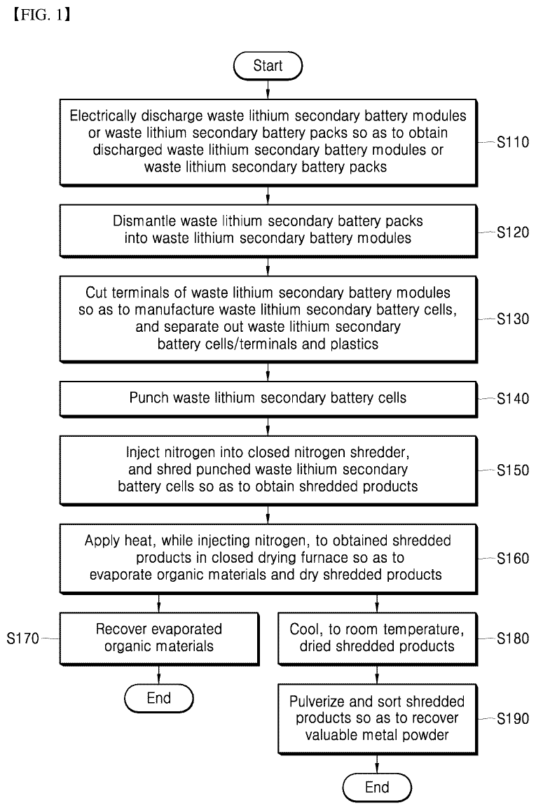

FIG. 1 is a process flow diagram of a pretreatment method for lithium secondary battery recycling according to an exemplary embodiment of the present disclosure.

Referring to FIG. 1, waste lithium secondary battery modules or waste lithium secondary battery packs may be electrically discharged to obtain discharged waste lithium secondary battery modules or discharged waste lithium secondary battery packs (S110).

Thereafter, the waste lithium secondary battery packs may be dismantled into waste lithium secondary battery modules (S120).

Then, the waste lithium secondary battery modules may be subjected to terminal cutting to manufacture waste lithium secondary battery cells, and the waste lithium secondary battery cells, terminals, and plastics may be separated (S130).

Subsequently, the waste lithium secondary battery cells may be punched (S140).

Then, nitrogen may be injected into a closed nitrogen shredder, and the punched waste lithium secondary battery cells may be shredded to obtain shredded products (S150).

Thereafter, the obtained shredded products may be introduced into a closed drying furnace, nitrogen is injected, and heat may be applied to evaporate organic materials and recover the dried shredded products (S160).

Then, the evaporated organic materials may be recovered (S170).

Thereafter, the dried shredded products may be cooled to room temperature (S180).

Then, the dried shredded products at room temperature may be pulverized and sorted to recover valuable metal powder (S190).

Hereinafter, the present disclosure will be described in more detail through exemplary embodiments. However, the following exemplary embodiments are provided for illustrative purposes only and are not intended to limit the scope of the present disclosure. The following exemplary embodiments may be appropriately modified or altered by those skilled in the art within the scope of the present disclosure.

### Preparative Example

Waste lithium secondary batteries for electric vehicles, which contain organic materials such as a separator, an electrolyte, and a binder in an amount of about 20 to 30 wt %, energy storage systems (ESS), and IT devices were prepared as waste batteries.

### EXEMPLARY EMBODIMENTS

### <Exemplary Embodiment 1> Pretreatment Process for Lithium Secondary Battery Recycling

In accordance with the pretreatment process for lithium secondary battery recycling shown in Table 1, 1 kg of the waste lithium secondary battery for electric vehicles prepared in the preparative example was discharged to obtain discharged waste lithium secondary batteries.

Thereafter, nitrogen was injected into a closed shredder, and the discharged waste lithium secondary batteries were shredded to approximately 60 mm using a shredder to obtain shredded products.

Then, the obtained shredded products were dried by indirect heating at 500 °C using a rotary-type dryer. Nitrogen was injected into the rotary kiln (a closed drying furnace) to maintain the oxygen concentration inside the facility at 1 vol % or less, thereby evaporating organic materials and recovering the dried shredded products.

Subsequently, the evaporated organic materials were recovered using a condenser.

Then, the hot dried shredded products were cooled to room temperature.

Thereafter, the dried shredded products were pulverized and sorted to recover valuable metal powder.

Subsequently, the contents of Cu and Al in the dried valuable metal powder obtained from the waste batteries were analyzed.

### <Exemplary Embodiments 2 to 7> Pretreatment Process for Lithium Secondary Battery Recycling

Waste batteries prepared in the preparative example were pretreated in the same manner as in exemplary embodiment 1, except that the pretreatment processes shown in Table 1 for lithium secondary battery recycling were applied.

### <Comparative Example 1> Pretreatment Process for Lithium Secondary Battery Recycling

Waste batteries were pretreated in the same manner as in exemplary embodiment 1, except that nitrogen was not used (air atmosphere) and the particle size of the shredded products was 30 mm.

### <Comparative Example 2> Pretreatment Process for Lithium Secondary Battery Recycling

Waste batteries prepared in the preparative example were pretreated in the same manner as in exemplary embodiment 4, except that nitrogen was not used (air atmosphere).

[TABLE 1]

| | Exemplary | Exemplary | Exemplary | Exemplary | Exemplary | Exemplary | Exemplary | Comparative | Comparative |
|---|---|---|---|---|---|---|---|---|---|
| | embodiment | embodiment | embodiment | embodiment | embodiment | embodiment | embodiment | example 1 | example 2 |
| Process | 1 | 2 | 3 | 4 | 5 | 6 | 7 | | |
| Waste | Waste | Waste | Waste | Waste | Waste | Waste | Waste | Waste | Waste |
| Battery | battery | battery | battery | battery | battery | battery for | battery for | battery | battery |
| Type | for EV | for EV | for ESS | for ESS | for EV | IT devices | IT devices | for EV | for ESS |
| Closed | Rotary | Rotary | Rotary | Rotary | Box | Rotary | Box | Rotary | Rotary |
| Drying | kiln | kiln | kiln | kiln | furnace | kiln | furnace | kiln | kiln |
| Furnace | | | | | | | | | |
| Gas | Nitrogen | Nitrogen | Nitrogen | Nitrogen | Nitrogen | Nitrogen | Nitrogen | Air | Air |
| Atmosphere | | | | | | | | | |
| Shredding | Shredder | Shredder | Shredder | Shredder | Shredder | Shredder | Shredder | Shredder | Shredder |
| Device | | | | | | | | | |
| Shredded | 60 | 30 | 60 | 30 | 50 | 30 | 50 | 30 | 30 |
| Product | | | | | | | | | |
| Size | | | | | | | | | |
| (mm) | | | | | | | | | |
| Drying | 500 | 500 | 500 | 500 | 400 | 500 | 400 | 500 | 500 |
| Temperature | | | | | | | | | |
| (° C.) | | | | | | | | | |
| Heating | Indirect | Indirect | Indirect | Indirect | Indirect | Indirect | Indirect | Indirect | Indirect |
| Method | heating | heating | heating | heating | heating | heating | heating | heating | heating |
| Organic | Condenser | Condenser | Condenser | Condenser | Heat | Condenser | Refrigerator | Condenser | Condenser |
| Material | | | | | exchanger | | | | |
| Recovery | | | | | | | | | |
| Device | | | | | | | | | |
| Cu | | | | | | | | | |
| Content | | | | | | | | | |
| in Dried | 0.9 | 0.7 | 1.2 | 1 | 1 | 0.9 | 1.2 | 3 | 4 |
| Powder | | | | | | | | | |
| (wt %) | | | | | | | | | |
| Al | | | | | | | | | |
| Content | | | | | | | | | |
| in Dried | 0.5 | 0.4 | 0.8 | 0.7 | 0.7 | 0.6 | 0.5 | 5 | 6 |
| Powder | | | | | | | | | |
| (wt %) | | | | | | | | | |

### EVALUATION EXAMPLES

### <Evaluation Example 1> Evaluation of Pretreatment Process for Lithium Secondary Battery Recycling—Fire and Explosion

In comparison to comparative examples 1 and 2, exemplary embodiments 1 to 4 did not cause fire or explosion during operation of the equipment, since nitrogen was injected into the closed drying furnace and organic materials were evaporated by indirect heating.

However, comparative examples 1 and 2 had a significant risk of fire and explosion due to the high oxygen concentration in the equipment during operation.

### <Evaluation Example 2> Evaluation of Pretreatment Process for Lithium Secondary Battery Recycling—Chemical Usage for Impurity Removal in Wet Process

In comparison to comparative examples 1 and 2, in exemplary embodiments 1 to 4, nitrogen was injected into the closed drying furnace and organic materials were evaporated by indirect heating. As a result, the evaporated organic materials were recoverable in the form of oil, gas, or ash, and the amount of chemicals required for impurity removal in the wet process was significantly reduced.

In contrast, in comparative examples 1 and 2, nitrogen was not used. Therefore, it was difficulty to remove organic materials, resulting in a significant increase in the amount of chemicals used for impurity removal in the wet process.

### <Analytical Example> Organic Materials Recovered by Pretreatment Process for Lithium Secondary Battery Recycling

The organic materials recovered by the pretreatment process for lithium secondary battery recycling of exemplary embodiment 1 were analyzed using gas chromatography (GC).

The evaporated organic materials included 210 g of octene oil, 75 g of carbon monoxide and methane gas, and 15 g of ash.

In the above, exemplary embodiments of a pretreatment method for lithium secondary battery recycling according to the present disclosure have been described. Morevoer, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

### INDUSTRY APPLICABILITY

The present disclosure may be utilized in the lithium secondary battery recycling industry.

1. A pretreatment method for lithium secondary battery recycling, comprising:
(a-1) electrically discharging a waste lithium secondary battery module or a waste lithium secondary battery pack so as to obtain the waste lithium secondary battery module in a discharged state or the waste lithium secondary battery pack in a discharged state;
(a-2) dismantling the waste lithium secondary battery pack into a waste lithium secondary battery module;
(a-3) cutting a terminal of the waste lithium secondary battery module so as to manufacture a waste lithium secondary battery cell, and separating the terminal and plastics from the waste lithium secondary battery cell;
(a-4) punching the waste lithium secondary battery cell;
(a-5) injecting nitrogen into a closed nitrogen shredder, and shredding the punched waste lithium secondary battery cell so as to obtain a shredded product;
(a-6) applying heat, while injecting nitrogen, to the obtained shredded product in a closed drying furnace so as to evaporate an organic material and dry the shredded product;
(a-7) recovering the evaporated organic material;
(a-8) cooling the obtained dried shredded product to room temperature; and
(a-9) pulverizing and sorting the obtained shredded product,
wherein, in the pretreatment method for lithium secondary battery recycling, nitrogen is injected into the closed drying furnace, a temperature inside a closed tube is maintained to be constant, and then heat is applied to the shredded product so as to effectively evaporate and recover the organic material of a waste lithium secondary battery, thereby controlling impurities of the waste lithium secondary battery.

2. The method of claim 1,
wherein, in the step (a-1) of electrically discharging a waste lithium secondary battery module or a waste lithium secondary battery pack so as to obtain the waste lithium secondary battery module in a discharged state or the waste lithium secondary battery pack in a discharged state,
the electrical discharge is performed by discharging for 1.5 to 3 hours and then short-circuiting for 24 hours.

3. The method of claim 1,
wherein, in the step (a-3) of cutting a terminal of the waste lithium secondary battery module so as to manufacture a waste lithium secondary battery cell, and separating the terminal and plastics from the waste lithium secondary battery cell,
the terminal is cut by using a terminal cutter,
the terminal and plastics are separated by using the terminal cutter, and
the terminal cutter includes an insulated terminal cutter, a metal cutter, or a high-speed cutter.

4. The method of claim 1,
wherein, in the step (a-4) of punching the waste lithium secondary battery cell,
a physical discharge is performed by the punching.

5. The method of claim 1,
wherein, in the step (a-5) of injecting nitrogen into a closed nitrogen shredder, and shredding the punched waste lithium secondary battery cell so as to obtain a shredded product,
the shredding is performed by using a shredder, a jaw crusher, or a cone crusher.

6. The method of claim 1,
wherein, in the step (a-5) of injecting nitrogen into a closed nitrogen shredder, and shredding the punched waste lithium secondary battery cell so as to obtain a shredded product,
the closed nitrogen shredder is supplied through a conveyor under a nitrogen atmosphere.

7. The method of claim 1,
wherein, in the step (a-5) of injecting nitrogen into a closed nitrogen shredder, and shredding the punched waste lithium secondary battery cell so as to obtain a shredded product,
the closed nitrogen shredder is a two-stage nitrogen shredder,
wherein a first-stage size of the two-stage nitrogen shredder is 30 to 60 mm in width and 130 to 200 mm in length, and
a second-stage size of the two-stage nitrogen shredder is 15 to 30 mm in width and 20 to 130 mm in length.

8. The method of claim 1,
wherein, in the step (a-6) of applying heat, while injecting nitrogen, to the obtained shredded product in a closed drying furnace so as to evaporate an organic material and dry the shredded product,
the nitrogen is introduced into the closed drying furnace through a closed transfer conveyor after passing through a nitrogen shredder.

9. The method of claim 1,
wherein, in the step (a-6) of applying heat, while injecting nitrogen, to the obtained shredded product in a closed drying furnace so as to evaporate an organic material and dry the shredded product,
the evaporation of the organic materials is performed in the closed drying furnace with nitrogen injected therein,
and the closed drying furnace is at least one selected from the group consisting of a rotary kiln, a rotary dryer, a tunnel furnace, a box furnace, and a furnace having a closed structure.

10. The method of claim 1,
wherein, in the step (a-6) of applying heat, while injecting nitrogen, to the obtained shredded product in a closed drying furnace so as to evaporate an organic material and dry the shredded product,
the evaporation of the organic materials is performed by an indirect heating method at a temperature of 100 °C to 800 °C.

11. The method of claim 1,
wherein, in the step (a-6) of applying heat, while injecting nitrogen, to the obtained shredded product in a closed drying furnace so as to evaporate an organic material and dry the shredded product,
the organic material is at least one selected from the group consisting of a combustible material including carbon or hydrogen, moisture, and ash.

12. The method of claim 1,
wherein, in the step (a-7) of recovering the evaporated organic material,
a device for recovering the evaporated organic material is at least one selected from the group consisting of a condenser, a cooling tower, a refrigerator, a heat exchanger, and a multi-pipe heat exchanger.

13. The method of claim 1,
wherein, in the step (a-8) of cooling the obtained dried shredded product to room temperature,
the cooling of the obtained dried shredded product is performed in a closed cooling device,
and the closed cooling device is at least one selected from the group consisting of a rotary type, a tunnel type, and a box type.

14. The method of claim 1,
wherein, in the step (a-8) of cooling the obtained dried shredded product to room temperature,
the cooling is performed by an indirect cooling method using a refrigerant in a closed cooling device at a temperature of 15 °C to 30 °C.

15. The method of claim 1,
wherein, in the step (a-8) of cooling the obtained dried shredded product to room temperature,
the dried shredded product discharged from a closed cooling device is discharged at a temperature of 25 °C to 40 °C.

16. The method of claim 1,
wherein, in the step (a-9) of pulverizing and sorting the obtained shredded product,
a pulverizer for the pulverizing is at least one selected from the group consisting of a rod mill, a pin mill, a ball mill, a tube mill, a pot mill, a roller mill, a turbo mill, an impact mill, a cut mill, and a tower mill.

17. The method of claim 1,
wherein, in the step (a-9) of pulverizing and sorting the obtained shredded product,
a size of the pulverized waste lithium secondary battery ranges from 10 μm to 15 mm.

18. The method of claim 1,
wherein, in the step (a-9) of pulverizing and sorting the obtained shredded product,
a device for the sorting is at least one selected from the group consisting of a gravity separator, a specific gravity separator, a vibrating separator, a magnetic separator, an electrostatic separator, a pneumatic separator, a flotation separator, and an optical separator.

19. The method of claim 1,
wherein, in the step (a-9) of pulverizing and sorting the obtained shredded product,
the obtained shredded product is sorted into at least one selected from the group consisting of a cathode active material, an anode active material, copper (Cu), and aluminum (Al).

20. The method of claim 1,
wherein, in the step (a-9) of pulverizing and sorting the obtained shredded product,
a valuable metal powder recovered by the pulverizing and sorting includes a compound of at least one valuable metal selected from the group consisting of lithium, nickel, manganese, cobalt, iron, aluminum, and copper.

21. The method of claim 1,
wherein the waste lithium secondary battery is at least one lithium secondary battery selected from the group consisting of a waste battery of an electric vehicle, a waste battery of an energy storage system (ESS), a waste battery of an electronic product, and a waste battery of a mobile phone.

22. The method of claim 1,
wherein the waste lithium secondary battery includes at least one selected from the group consisting of a cathode active material, an anode active material, a separator, a copper (Cu) foil, an aluminum (Al) foil, and an electrolyte.
